(19) United States
(12) Patent Application Publication
(10) Pub. No.: US 2011/0040497 A1
(43) Pub. Date: Feb. 17, 2011

(54) METHOD FOR SENSING STRAIN IN A COMPONENT IN A WIND TURBINE, OPTICAL STRAIN SENSING SYSTEM AND USES THEREOF

(75) Inventor: Ib Svend Olesen, Randers NO (DK)

Correspondence Address: WOOD, HERRON & EVANS, LLP, 2700 CAREW TOWER, 441 VINE STREET, CINCINNATI, OH, 45202, US

(73) Assignee: VESTAS WIND SYSTEMS A/S, Randers SV (DK)

(21) Appl. No.: 12/864,930

(22) PCT Filed: Jan. 27, 2009
(86) PCT No.: PCT/DK09/50027

§ 371 Date: Sep. 24, 2010

Related U.S. Application Data
(60) Provisional application No. 61/024,033, filed on Jan. 28, 2008.

(30) Foreign Application Priority Data
Jan. 28, 2008 (DK) PA 2008 00109
Mar. 7, 2008 (DK) PA 2008 00346

(51) Int. Cl. G06F 19/00; G01B 11/16; G01L 1/24

(52) U.S. Cl. 702/34; 356/32

(57) ABSTRACT

The invention relates to a method for sensing strain in a component in a wind turbine comprising an optical sensor system. The method comprises the step of inputting a optical signal into at least one optical fibre of said sensor system comprising one or more fibre Bragg grating sensors. Further, the method comprises the step of measuring the transmitted optical signals of said one or more sensors with at least one light detector connected to the other end of said at least one optical fibre, and processing the measured signals in a control unit in order to establish a value of the strain for the component. The invention also relates to an optical strain sensing system for a component in a wind turbine and uses hereof.

### BACKGROUND OF THE INVENTION

The invention relates to a method for sensing strain in a component in a wind turbine, optical strain sensing system and uses hereof.

Optical sensors using fibre Bragg grating (FBG) have previously been provided in wind turbine components in order to monitor the applied strain e.g. as disclosed in U.S. Pat. No. 6,940,186. The strain on a component may originate from a number of sources such as the power of the wind, layers of dirt or ice on the wind turbine blades, the own weight of the component and different combinations of the sources.

A FBG sensor comprises a type of distributed Bragg reflector constructed in a short segment of an optical fibre and reflecting a particular wavelength of light. The particular wavelength of the FBG sensor is achieved by adding a periodic variation to the refractive index of the fibre, which generates a wavelength specific dielectric mirror. By adding different periodic variations to the refractive index of the optical fibre it is possible to establish a system with distributed FBG sensors reflecting light signals of different wavelengths.

The well-known FBG sensor system a disadvantage in that a complex and expensive interrogator is used for recording and analysing outputted wideband light returned by reflection in the optical fibre by the FBG sensors. The interrogator is usually connected to a section of optical fibre which is branched of with a Y-connection from the optical fibre with the FBG sensors. The interrogator is located upstream relative to the FBG sensors and is adapted to analyse a wideband light signal of light reflected from a plurality of FBG sensors, which each are arranged to reflect light with an individual and distinct narrowband light signal.

The object of the invention is to provide improved FBG sensor technique and especially without the abovementioned disadvantage.

### THE INVENTION

The invention relates to a method for sensing strain in a component in a wind turbine comprising an optical sensor system, said method comprising the steps of:

inputting a narrowband input optical signal into at least one optical fibre of said sensor system, said optical fibre comprising one or more fibre Bragg grating sensors,

measuring a transmitted output optical signal influenced by said one or more sensors, in response to the input optical signal, with at least one light detector, said light detector being operatively connected to the optical fibre and located downstream relative to said one or more sensors, and

processing the measured output optical signal in a control unit in order to establish a value of a strain in the component.

The narrowband optical signal may be tuned to one or more specifically targeted sensors whereby the processing of the measured output optical signal is significantly simplified compared to analysing a wideband signal. A complex interrogator may hereby be dispensed with. That is, since the input signal may have a narrow linewidth with a centre wavelength, and since the tuning or sweeping of the centre wavelength may be performed according to a predetermined temporal wavelength tuning, individual wavelengths of input signal may be temporally distinguishable by the light detector or the control unit and, therefore, a wavelength analyser, e.g. an interrogator, may be dispensed with. Moreover, by placing the light detector downstream of the sensors it does not have to be connected to a section of optical fibre which is Y-branched from the optical fibre having the sensors. A possible signal intensity reduction in the Y-connection may thereby be avoided.

According to the method a light intensity of the output optical signal may be measured with the light detector over a frequency band selected according to the grating sensors, and where the output optical signal comprises at least one notch which represents a minimum light intensity, and where the position of the notch is detected in order to ascertain a strain value. The position of the notch is representative of the amount of strain.

According to the method a light intensity of the transmitted output optical signal is compared with a light intensity of the input optical signal. This provides a normalisation and/or calibration of the output optical signal, which enables a more precise measurement of the position of the notch and hence of the strain.

Further according to the method the optical fibre may comprise a plurality of sensors, and the input optical signal over time may be tuned to different frequencies corresponding to an operational mode of at least two sensors. It is hereby obtained that strains in at least two sensors may be detected, when the sensors are adapted for reflecting optical signals of different frequencies/wavelengths of the input optical signal. Moreover, it is known which sensor is transmitting a signal in certain point in time. This is known from the frequency of the input signal at that certain point in time. Accordingly, the inputting of a narrowband input optical signal may comprise tuning or sweeping the input signal over a range of wavelengths covering the operating wavelengths of one or more sensors.

Furthermore, the processing of the measured output optical signal may be performed according to the tuned frequency of the input optical signal. The processing is hereby simplified because a wideband measurement can be disposed of. It is only necessary to perform the measurement over a frequency range adapted to the frequency or narrowband frequencies of the input optical signal.

Further according to the method a frequency of the output signal may be given by a frequency of the input optical signal. That is, when the input optical source is instructed to transmit an optical signal with a given frequency, the light sensor almost simultaneously measures the transmitted input signal and, therefore, the frequency of the output signal is given by the frequency of the input signal. Accordingly, it is not required to measure the frequency/wavelength of output signal using a spectrometer or an interrogator.

In a further aspect of the invention, said value of the strain is supplied to the wind turbine controller. Hereby it is possible to introduce the strain values in the overall wind turbine control in order to decrease the maintenance costs of the components and increase the reliability of the wind turbine as such. E.g. if the strain values are approaching a too high level the wind turbine may be controlled to reduce the strain values, or even stop the wind turbine.

In an even further aspect of the invention, said value of the strain is used in the pitch control of at least one wind turbine blade and/or in the power generation control of the wind turbine. Hereby it is possible to reduce the strain to a wind turbine component e.g. by pitching a wind turbine blade more or less out of the wind and reducing the power generation of the wind turbine in a period of significant wind gusts.

The invention also relates to an optical strain sensing system for a wind turbine component, the strain sensing system comprising

at least one optical fibre which is operatively connected to said turbine component and comprising one or more fibre Bragg grating sensors,

a narrowband input optical signal source connected to said optical fibre at a location upstream to said one or more sensors,

at least one light detector operatively connected to the optical fibre at a location downstream of one or more sensors, said light detector being arranged for measuring transmitted output optical signals influenced by one or more of said sensors, and

at least one control unit for processing the measured output optical signals in order to establish a value of a strain in the component.

Hereby is achieved an optical strain sensing system without the abovementioned disadvantages. The sensing system may be used as a safety system in a strong wind situation, but may also be used as a general optimizing system in normal operation e.g. leading to fewer loads on the structure of the turbine. Also, the expensive and complex interrogator may hereby be dispensed with. The described strain sensing system according to the invention is simpler and less costly than the systems which are currently commercially available.

In a preferred embodiment the input optical signal is split into at least two optical fibres, which each comprises at least one fibre Bragg grating sensor. Hence, at least two separate strain measurements may be performed.

In another preferred embodiment a light detector is operatively connected to each of the optical fibres and located downstream relative to the sensor in each optical fibre, By including a light detector connected to each optical fibre at least two strain measurements may be performed at the same time, which speed up operation of the system.

The input optical signal source may be a laser, which is tunable with respect to a frequency of the input optical signal, or a broadband light source and a filter which is tunable with respect to a frequency of the input optical signal. The laser may provide a more narrowband optical signal, which may enable a more precise strain measurement or a more certain tuning of the light signal to one specific FBG sensor.

A broadband (wideband) light source and a filter may on the other hand provide a less costly embodiment of the system.

In a further preferred embodiment of the system the optical fibre comprises a plurality of sensors, and the input optical signal is tunable to different frequencies corresponding to operational modes of at least two sensors.

In an aspect of the invention, the system comprises data storage means for keeping record of the strains in a wind turbine component. Hereby it is possible to estimate the remaining lifetime or safe working condition of the component. The component may be e.g. a wind turbine blade and thus the need for service of the component may be predicted.

The invention further relates to a use of a method according to the invention in wind turbine components such as the wind turbine blades, the main shaft, main bearings and the gearbox in order to sense strain.

### FIGURES

The invention will be described in the following with reference to the figures in which

FIG. 1 illustrates a large modern wind turbine,

FIG. 2 illustrates an example of an well-known optical FBG sensor system for a wind turbine blade,

FIG. 3 illustrates an embodiment of an optical strain sensing system for a wind turbine blade according to the invention,

FIG. 4 illustrates an embodiment of the light and control means of the optical strain sensing system of FIG. 3 in further details,

FIG. 5A-C illustrates principles of tuning the wavelengths of the input optical source over a wavelength range of the sensors, and

FIG. 6 illustrates tuning the input optical source over wavelength range covering a plurality of sensors.

### DETAILED DESCRIPTION

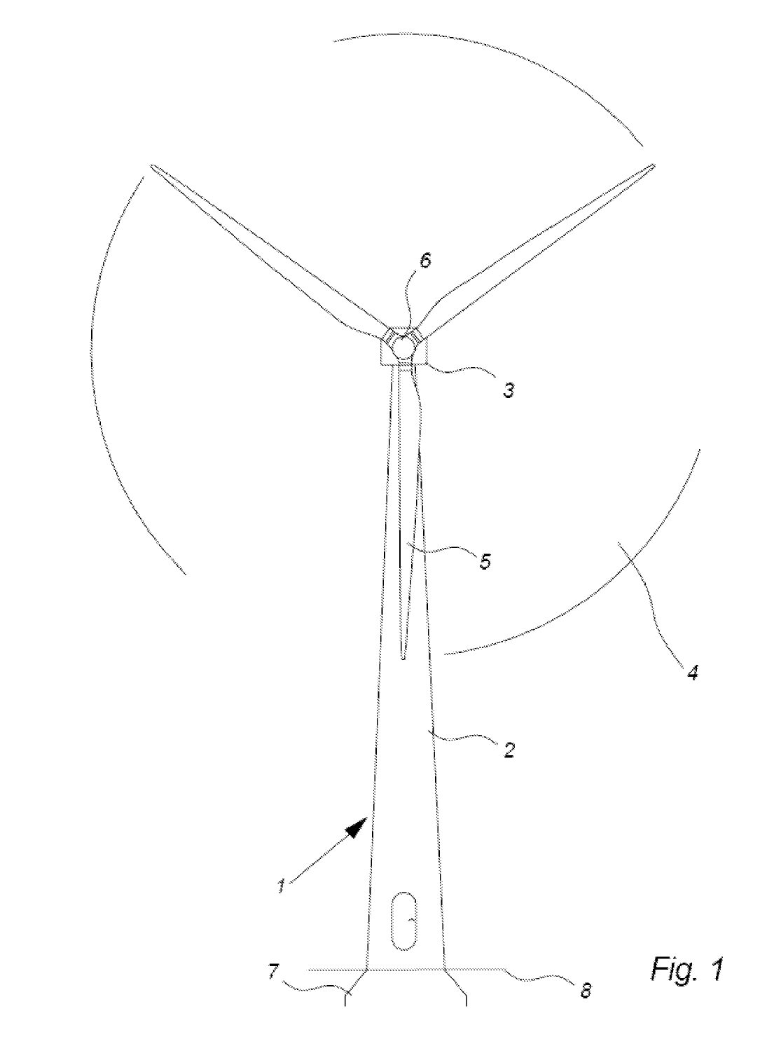

FIG. 1 illustrates a wind turbine 1, comprising a wind turbine tower 2 and a wind turbine nacelle 3 positioned on top of the tower 2. The wind turbine rotor 4 comprises at least one wind turbine blade e.g. three wind turbine blades 5 as illustrated in the figure. The rotor is mounted on a hub 6, which is connected to the nacelle 3 through the low speed shaft extending out of the nacelle front.

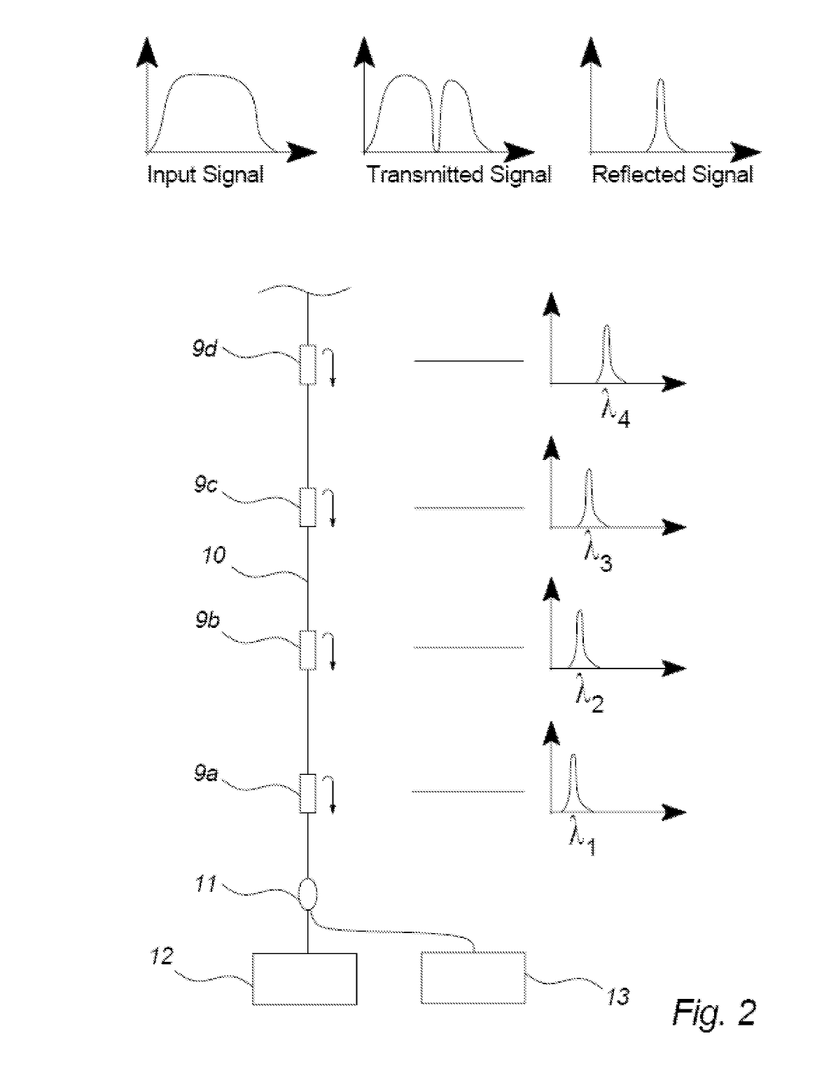

FIG. 2 illustrates a well-known optical strain sensing system using the principle of fibre Bragg gratings as initially explained above.

The system includes an optical fibre 10 with a number of FBG sensors 9a-9d distributed in the fibre.

A light source 12 applies an input signal to the end of the fibre prior to an optical splitter 11 wherein an example of an input signal is illustrated in the upper left corner of the figure.

Each FBG sensor reflects a reflected signal of a specific wavelength (9a_lambda1; 9b_lambda2, 9c_lambda3, 9d_lambda4 . . . ) toward the light source 12 as illustrated in the upper right corner of the figure for the initial sensor 9a of the fibre 10. For convenience, it may be said that a sensor reflects a specific wavelength, e.g. lambda1. However, in fact the sensor reflects a spectral wavelength distribution which may have a centre wavelength or a peak wavelength of lambda1. FIG. 2 illustrates such spectral distributions with distinct centre wavelengths of lambda1-lambda4.

Further, each FBG sensor transmits a transmitted signal toward the next sensor wherein the transmitted signal is filtered of the wavelength specific for the sensor as illustrated in the upper center of the figure for the initial sensor 9a of the fibre 10.

The Y-connector 11 lets the input light pass on to the FBG sensors but deflects and sends the reflected signals with the wavelengths lambda1-lambda4 to an interrogator 13 which detects the signals.

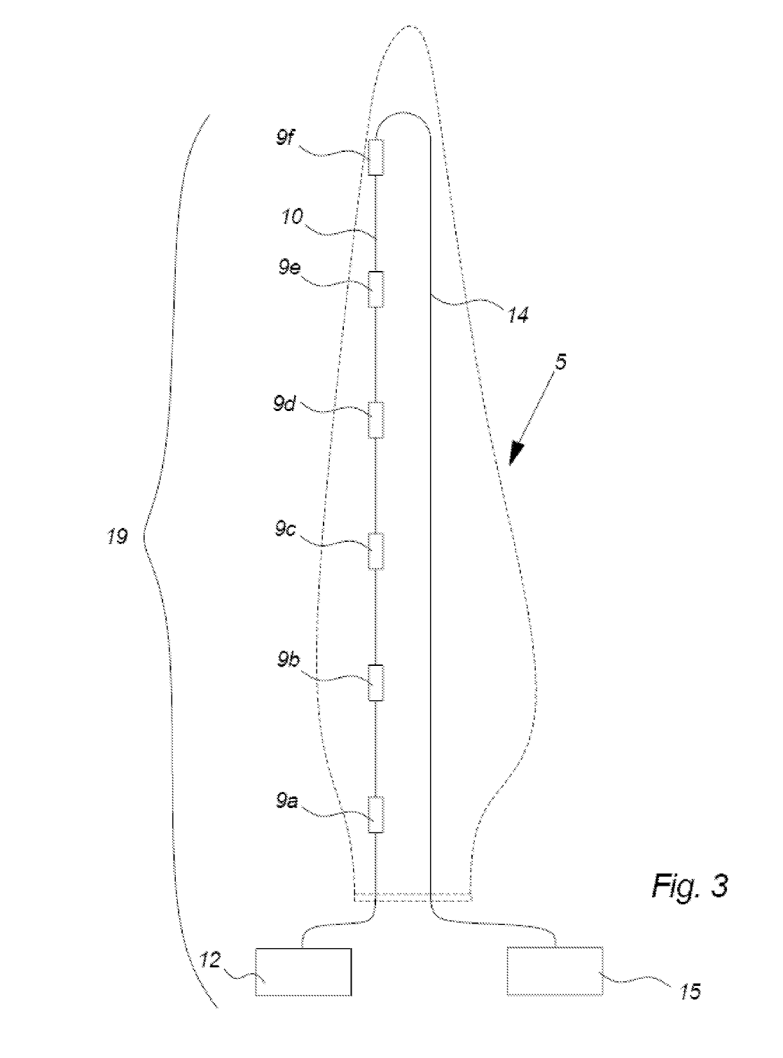

FIG. 3 illustrates an embodiment of an optical strain sensing system 19 for a wind turbine blade 5 according to the invention. The wind turbine blade 5 comprises the FBG sensors and optical fibres wherein the fibre ends may be located in the hub of the wind turbine together with the light source and detector means as well as the accompanying control means.

The optical fibre 10 of the illustrated optical strain sensing system 19 is not terminated after the last FBG sensor 9 but continues in an optical fibre 14 to a light detector 15 for the transmitted light signals of the FBG sensors.

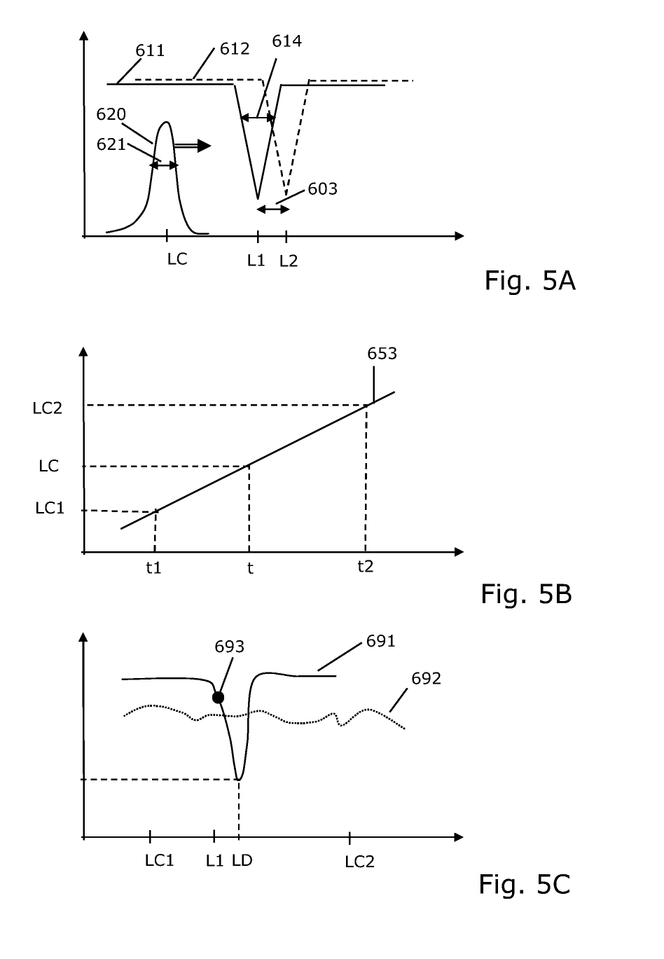

FIG. 5A-C illustrates the principle of an embodiment of the invention. FIG. 5A shows the transmission filter characteristic 611 of a FBG sensor. The abscissa of the coordinate system represents wavelength and the ordinate represents the transmittivity of a FBG sensor. The transmission characteristic shows a minimum transmittivity at the wavelength L1 and a filter notch in the vicinity of the wavelength L1. When the FBG sensor is exposed to strain, the minimum transmittivity, and the filter notch, may be displaced from wavelength L1 to wavelength L2 as shown by the transmission characteristic 612. Accordingly, by measuring the displaced wavelength L2 or the wavelength displacement 603, the strain of the FBG sensor can be determined.

In addition, FIG. 5A illustratively shows the spectral intensity profile 620 of the narrowband input optical signal which has a bandwidth or linewidth 621 and a centre wavelength LC.

The linewidth 621 of the input signal should not be too broad in comparison with the notch-width 614 of the FBG sensor. For example, the linewidth 621 may be less than five times the notch-width 614, less than two times the notch width, less than 0.5 times the notch width or even less than 0.1 times the notch width. It may be desirable to use a small line-width since a small line-width may provide improved signal-to-noise ratios. As an example, a FBG sensor may have a minimum transmission wavelength L1 of e.g. 1500 nm and a notch-width 614 of 0.2 nm. The linewidth 621 may be 0.1 nm.

The filter transmission characteristic 611 of a FBG sensor is created by alternating or periodic variations in the refractive index of the fibre 10. Thus, the FBG sensor 9a may be seen as number of sections of the fibre 10 having varying values of the refractive index. In order to obtain a FBG sensor with a minimum transmission wavelength L1 of e.g. 1500 nm, the distance between adjacent fibre sections with different refractive indices should satisfy a given Bragg condition. Assuming a refractive index of approximately 1.5 of one of the sections, the distance between succeeding sections—or equivalently, the period of periodic variations in the refractive index—is approximately 500 nm, i.e. approximately one third of the wavelength L1.

Accordingly, the grating period of the periodic variations in the refractive index relates to the nominal filter wavelength L1 of a FBG sensor and, thereby, the wavelength of the narrowband input optical signal. Wavelengths of the input optical signal may range from 300 nm to 6000 nm or preferably from 600 nm to 2000 nm.

Since the grating period depends on the refractive index of the fibre and other factors, such as desired filter characteristics, the grating period for FBG sensors used according to embodiments of this invention may range from 100 nm to 5000 nm. Grating periods in the range from 100 nm to 5000 nm may be used with wavelengths of the input optical signal ranging from 300 nm to 15000 nm, as explained above.

The FBG sensor and, thereby, the grating period, may be made by different processing of a fibre. For example, the fibre can be illuminated with UV light to form gratings. Accordingly, different grating periods may be selected according to the grating processing of a fibre. For example, different FBG sensors in a fibre may have different grating periods generated by the processing of the fibre.

Thus, in an embodiment of a method for sensing strain and an embodiment of an optical strain sensing system, the grating period of periodic variations in the refractive index of a Bragg grating sensor may be within the range from 100 nm to 5000 nm, preferably within the range from 100 nm to 1000 nm or more preferred within the range from 200 to 700 nm.

The transmitted output optical signal is influenced by the one or more FBG sensors, in response to the input optical signal. Thus, the influence by the FBG sensors on the output optical signal is determined at least in part by the grating period of a FBG sensor. The grating period may be selected to improve detection by the detector located downstream relative to the one or more FBG sensors, for example by adapting the notch-width 614 to the linewidth 621 of the input signal, i.e. by making the notch-width 614 wider than the linewidth 621 so as to obtain more accurate detection.

Detection by the downstream detector may also be improved for example by selecting the grating period to minimise the minimum transmittivity of a FBG sensor at wavelength L1. Thus, if there is a large difference between the minimum transmittivity and the transmittivity outside the filter notch, detection of transmitted light may be made with greater accuracy.

Thus, the grating period of the FBG sensors may be selected to particularly improve detection by a downstream detector 15, 15a-c according to methods for sensing strain and optical strain sensing systems of the invention.

In a method for sensing strain and a strain sensing system, where a light intensity of the output optical signal is measured with the light detector over a frequency band selected according to the grating sensors, the frequency band may given according to the range of wavelengths covering distinct notch wavelengths L1 of different FBG sensors. Accordingly, the distinct grating periods may be selected to match a given frequency band of the light detector 15, 15a-c.

In a method for sensing strain and a strain sensing system, the minimum light intensity of at least one notch of the output optical signal is determined at least in part by the grating period of at least on FBG sensor. Thus, the minimum light intensity of a notch may be determined by selecting a given grating period in order to obtain a particular transmission profile 611.

In a method for sensing strain and a strain sensing system the optical fibre comprises a plurality of sensors, and the input optical signal is tuned to different frequencies over time corresponding to an operational mode of at least two sensors. The different frequencies corresponding to an operational mode of FBG sensors may be determined at least in part by the different grating periods of FBG sensors. Accordingly, the range of different frequencies over which the input optical signal is tuned may be determined by the different grating periods of the FBG sensors. Therefore, the grating periods may be selected according to an available tuning range of the input optical signal.

By sweeping or tuning the centre wavelength LC of input optical signal over the operational mode of one or more FBG sensors, that is, by sweeping or tuning the centre wavelength LC over a wavelength range including the spectra of the filter-notches of the sensors, the strain of an FBG sensor may be determined by measuring the transmitted output optical signal, e.g. the output light intensity, and processing the measured output signal to determine the wavelength displacement 603.

FIG. 5B illustrates how the centre wavelength LC of the input optical source may be swept or tuned by adjusting the centre wavelength LC according to the linear curve 653. In FIG. 5B the abscissa represents time and the ordinate represents the centre wavelength. Thus, the tuning of the centre wavelength LC may be controlled, for example by sweeping the centre wavelength LC with a constant rate-of-change, so that wavelength is linearly increased from wavelength LC1 at time t1 to wavelength LC2 at time t2. Even though the wavelength LC of the input optical source may be tuned according to some predefined curve 653 in one embodiment, in other embodiments the input optical source is not tuned according to any specific curve 653. In still other embodiments, the input optical source is tuned according to a staircase curve, parabolic, elliptic, exponential or non-linear curves 653.

FIG. 5C shows a measurement of transmitted optical power 691 of a transmitted output optical signal, which may have been obtained by measuring the optical power or intensity at the end of the fibre 14 while the input optical signal is tuned over a wavelength range including one or more filter-notches of the FBG sensors. The abscissa represents wavelength and the ordinate represents for example measured optical power or intensity. By processing the measured optical output signal in a control unit, it is possible to determine the wavelength LD where the output signal has a minimum optical power. By comparing the determined filter wavelength LD with the nominal filter wavelength L1 representing the notch-wavelength when the FBG sensor is not strained, the wavelength difference 603 and, thereby, the actual strain at the location of the sensor can be determined.

Curve 692 in FIG. 5C illustrates the optical power or light intensity of the narrowband input optical signal as a function of wavelength during a tuning from centre wavelength LC1 to LC2. The non-constant intensity of the input signal, as illustrated by the variations of the curve 692, may affect the correctness of the determination of a wavelength position of a notch-filter and, hence, the wavelength difference 603 and the strain. However, by comparing the light intensity of the transmitted output optical signal with the light intensity of the input optical signal, it is possible to compensate more or less for the variations of the light intensity of the input signal. Thus, the comparison may comprise calculating the ratio of the measured transmitted optical intensity 691 and the input intensity 692. The comparison provides a normalisation and/or a calibration of the output optical signal. Accordingly, the transmitted optical light intensity curve 691 may equally be constituted by the ratio of the output signal and the input signal. Additionally, the comparison may comprise determining mean values of the input and/or output signals.

The ratio may be calculated real-time by measuring the intensity of the input optical intensity 692 and determining the ratio of the measured input intensity with the output intensity. The ratio may be determined by analogue electronics circuits or digital electronics connected to the measuring device of input source 12 and the light detector 15. Alternatively, the ratio may be determined subsequent to performing the tuning of the input optical signal, by storing values both of the measured input optical intensity and the measured output optical intensity and using the stored values for determining the ratio of the input and output intensities.

In another alternative, the input intensity characteristic 692 may be stored as a reference signal so that repeated measurements of the input signal are not required. Thereby, the ratio of the input signal and the output signal can be determined from the stored reference input signal and the real-time measured output signal or the stored output signal. The reference input signal may be measured and stored only once, e.g. during assembly of the optical strain sensing system or the reference input signal may be measured and stored at demand or at fixed intervals, e.g. every week.

In a less preferred embodiment, the wavelength LD where the measured transmitted output signal has the lowest intensity may be determined by measuring the output signal with a spectrometer simultaneously with tuning or sweeping the input signal source.

In another embodiment, the wavelength LD is determined by utilising that the centre wavelength LC of the input signal 692 is adjusted according to a predetermined curve 653 so that the wavelength at a give point in time is known. Accordingly, since the time-points of samples 693 of the measured output intensity 691 or the determined input-output ratio 691 are known, e.g. from an analogue-to-digital converter, the output samples 693 with time-points to can be compared with input signal samples having identical or corresponding time-points ti.

Clearly, the wavelength tuning of the input signal 692 may be synchronised with the intensity measurements of the output signal 691. Thus, when the input optical source 12 is controlled to generate a centre wavelength LC1 at time t1, a synchronisation signal may be provided to the light detector 15 or a control unit connected to the detector 15, which synchronisation signal provides information to the detector 15 or the controller 16 about the centre wavelength LC currently being transmitted through the fibre 14. In this way, it is known that the measured output signal has the wavelength LC1 since it was measured at time t1 or close to time t1. In the same way, the tuning of the input source over a range of light wavelengths LC (or equivalently light frequencies) from LC1 to LC2 during the time interval from t1 to t2 enables the determination of one or more wavelengths LD of minimum intensities corresponding to one or more wavelengths L2 of corresponding one or more notch-filters. Thus, by using a narrowband input signal and sweeping the narrowband spectrum over a range of wavelengths, the wavelength of the output signal is always given by the simultaneously, or the approximately simultaneously, wavelength of the input optical signal. Due to the finite speed of light there is a minor delay from inputting the input signal to measuring the output signal and, therefore, the output signal is only approximately simultaneously with the input signal. However, since this delay is normally much smaller than the duration of a tuning of the input optical source 12, the delay for the light propagation through the fibre 14 can normally be neglected.

The point of time when the measured output signal 691 has the smallest light intensity may be determined using various mathematical methods or simply by searching for the smallest light intensity over a time interval, e.g. from t1 to t2.

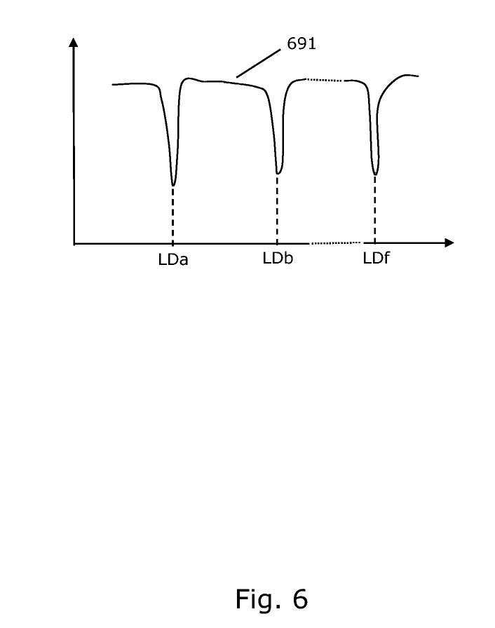

By tuning the input source 12 over a range of wavelengths covering a number of FBG sensors 9a-9f having distinct notch wavelengths L1, a measured output signal, as shown in FIG. 6, may be obtained from which wavelengths LDa-LDf corresponding to displaced notch-wavelengths L2 can be determined. Thus, by determining the wavelengths LDa-LDf for individual FBG sensors 9a-9f the strain values at various locations along a component 5 of a wind turbine can be determined. The FBG sensors 9a-9f may have individual notch wavelengths L1, for example 1500 nm, 1505 nm, 1510 nm etc. for individual sensors.

The tunable input source 12 may be a distributed feedback laser where the wavelength or frequency of the laser's output beam is made tunable e.g. by adjusting the temperature of a dispersive optical component. Alternatively, a broadband light source with a fixed spectral output may be made tunable by filtering the output beam using e.g. a filter wheel.

When the description refers to the frequency of the input signal or the output signal this is equivalent with the wavelength of the input signal or the output signal.

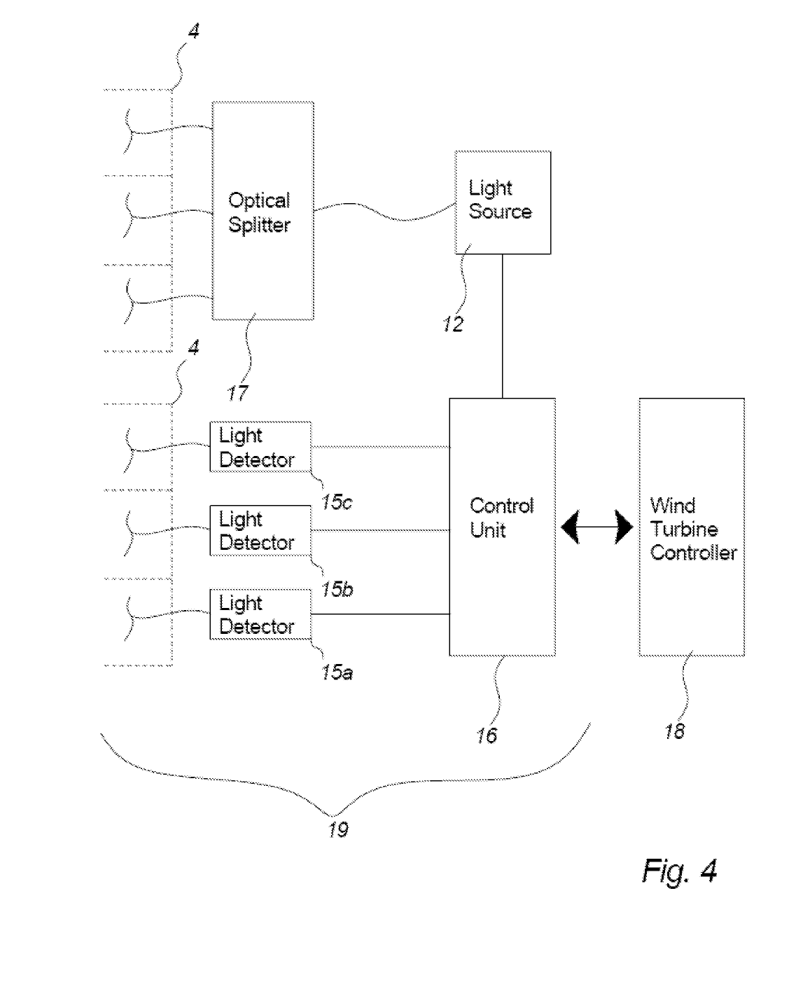

FIG. 4 illustrates an embodiment of the light and control means of the optical strain sensing system 19 of FIG. 3 in further details.

The control unit 16 directs the tunable light source 12 to sweep the relevant light range.

The light is divided into three signals by an optical splitter 17, which sends the light into three fibres, one for each blade of the wind turbine rotor 4.

In the blades the light passes through the FBG sensors which each transmits light of a certain wavelength. After passing all the FBG sensors in the blade, the fibres end in a light detector 15a-15c that measures the magnitude of the light intensity, and continuously sends this information to the control unit 16.

When the blade is exposed to some strain, it may bend or stretch a little, thus changing the length of the mounted fibre, and hence of the sensors, whereby a change in the reflection or transmission of light is changed at a given wavelength. The accompanying light detector measures the change of the fibre sensors, and the strains may be calculated. When the control unit 16 detects a change in the magnitude signal, the present wavelength of the tunable light source is comparable to the wavelength of a specific FBG sensor.

Thus, as the control unit 16 tunes the centre wavelengths to sweep a spectral range covering one or more sensors 9a-9f, e.g. from wavelength LC1 to LC2, the control unit 16 may simultaneously receive measured light intensities from the light detector 15a-15c. Since a particular wavelength of the input signal is generated substantially simultaneously with the measurement of the transmitted input signal with that particular wavelength, the control unit 16 knows the wavelength of the measured signal. Accordingly, when the control unit 16 has located a minimum light intensity of a notch-filter, the control unit 16 also knows the wavelength LD of that minimum light intensity location and, therefore, the wavelength displacement 603 and the strain can be determined. The analysis of the transmitted signal 691 may be performed in real-time, i.e. during the tuning of an optical input source 12, or the analysis may be performed on basis of stored measurements subsequent to the tuning of the input source 12. The strain signals of the control unit 16 are transmitted to the wind turbine controller and may be used in the overall control of the wind turbine.

The component may be any component. Elongated components, such as wind turbine blades, will normally be exposed to more strain than relatively short components. Hence the component will often be an elongated component, but not exclusively.

### LIST

1. Wind turbine
2. Wind turbine tower
3. Wind turbine nacelle
4. Wind turbine rotor
5. Wind turbine blade
6. Wind turbine hub
7. Wind turbine foundation
8. Ground level
9a-9f. Fibre Bragg grating sensor
10. Optical fibre
11. Y-connector
12. Light source
13. Interrogator
14. Optical fibre
15, 15a-15c. Light detector for transmitted light signals
16. Control unit for the optical strain sensing system
17. Optical splitter for splitting the input signal
18. Wind turbine controller
19. Optical strain sensing system

1. A method for sensing strain in a component in a wind turbine comprising an optical sensor system, the method comprising the steps of:
inputting a narrowband input optical signal into at least one optical fibre of the sensor system, the optical fibre comprising one or more fibre Bragg grating sensors,
measuring a transmitted output optical signal influenced by the one or more sensors, in response to the input optical signal, with at least one light detector, the light detector being operatively connected to the optical fibre and located downstream relative to the one or more sensors, and
processing the measured output optical signal in a control unit in order to establish a value of a strain in the component.

2. The method for sensing strain according to claim 1, where a light intensity of the output optical signal is measured with the light detector over a frequency band selected according to the grating sensors, and where the output optical signal comprises at least one notch which represents a minimum light intensity, and where the position of the notch is detected in order to ascertain a strain value.

3. The method for sensing strain according to claim 1 where a light intensity of the transmitted output optical signal is compared with a light intensity of the input optical signal.

4. The method for sensing strain according to claim 1, where the optical fibre comprises a plurality of sensors, and where the input optical signal over time is tuned to different frequencies corresponding to an operational mode of at least two sensors.

5. The method for sensing strain according to claim 4, where processing of the measured output optical signal is performed according to the tuned frequency of the input optical signal.

6. The method for sensing strain according to claim 1, where a frequency of the output signal is given by a frequency of the input optical signal.

7. The method for sensing strain according to claim 1, where the value of the strain is supplied to the wind turbine controller.

8. The method for sensing strain according to claim 1, where the value of the strain is used in the pitch control of at least one wind turbine blade and/or in the power generation control of the wind turbine.

9. An optical strain sensing system for a wind turbine component, the strain sensing system comprising:
at least one optical fibre which is operatively connected to the turbine component and comprising one or more fibre Bragg grating sensors,
a narrowband input optical signal source connected to said optical fibre at a location upstream to said one or more sensors,
at least one light detector operatively connected to the optical fibre at a location downstream of one or more sensors, said light detector being arranged for measuring transmitted output optical signals influenced by one or more of said sensors, and
at least one control unit for processing the measured output optical signals in order to establish a value of a strain in the component.

10. The optical strain sensing system according to claim 9, where the input optical signal is split into at least two optical fibres, which each comprises at least one fibre Bragg grating sensor.

11. The optical strain sensing system according to claim 10, where a light detector is operatively connected to each of the optical fibres and located downstream relative to the sensor in each optical fibre.

12. The optical strain sensing system according to claim 9, where the input optical signal source is a laser, which is tunable with respect to a frequency of the input optical signal.

13. The optical strain sensing system according to claim 9, where the input optical signal source is a broadband light source and a filter which is tunable with respect to a frequency of the input optical signal.

14. The optical strain sensing system according to claims 12 or 13, where the optical fibre comprises a plurality of sensors, and where the input optical signal is tunable to different frequencies corresponding to operational modes of at least two sensors.

15. The optical strain sensing system according to claim 9 comprising means for implementing a method according to claim 1.

16. The optical strain sensing system according to claim 9, wherein the system comprises data storage means for keeping record of the strains in the wind turbine component in order to estimate remaining safe working condition of the component.

17. The method according to claim 1, wherein the wind turbine component for which the strain is sensed is selected from the group consisting of a wind turbine blade, a tower, a shaft, a bearing, or a gearbox.

18. A wind turbine comprising a strain sensing system according to claim 9.
